(19) United States
(12) Patent Application Publication
(10) Pub. No.: US 2020/0409483 A1
(43) Pub. Date: Dec. 31, 2020

(54) INPUT CONTROL DEVICE, INPUT SYSTEM, AND INPUT CONTROL METHOD

(71) Applicant: MITSUBISHI ELECTRIC CORPORATION, Tokyo (JP)

(72) Inventor: Naoki KADOTA, Tokyo (JP)

(73) Assignee: MITSUBISHI ELECTRIC CORPORATION, Tokyo (JP)

(21) Appl. No.: 16/976,725

(22) PCT Filed: Mar. 26, 2018
(86) PCT No.: PCT/JP2018/012114

§ 371 Date: Aug. 28, 2020

(51) Int. Cl. G06F 3/039; G06F 3/0362; G06F 3/0484; G06F 3/038

(52) U.S. Cl. CPC G06F 3/0393; G06F 3/038; G06F 3/0484; G06F 3/0362

(57) ABSTRACT

An operation determination unit (21) determines whether or not a rotational operation or a decision operation has been performed on an operation device (11), on a basis of at least either a set of contact positions of multiple protrusions (11a) or a set of pressing forces of the multiple protrusions (11a) detected by a touch panel (12). A rotation amount storing unit (22) stores, when it is determined by the operation determination unit (21) that the rotational operation has been performed, information of a rotation amount due to the rotational operation. A control unit (23) controls, when it is determined by the operation determination unit (21) that the decision operation has been performed, a control target device by using information of the rotation amount stored in the rotation amount storing unit (22).

### TECHNICAL FIELD

The present invention relates to an input control device, an input system and an input control method, each using an operation device to be operated on a touch panel integrated with a display.

### BACKGROUND ART

An operational-information input system according to Patent Literature 1 includes a touch panel integrated with a display, an operation device to be operated on the touch panel, and an information processing device that serves to receive an operation using the operation device for inputting information. When the operation device is rotationally operated, the information processing device enlarges or reduces an image displayed on the display, according to an amount of rotational change of the operation device.

### CITATION LIST

### Patent Literature

Patent Literature 1: Japanese Patent Application Laid-open No. 2013-178678

### SUMMARY OF INVENTION

### Technical Problem

According to such a conventional operational-information input system, when the operation device is rotationally operated, in real time, its operation content is reflected in the information processing device. Thus, there is a problem that an operation unintended by the operator may be executed.

For example, during stopping of a vehicle at a traffic light, when the driver rotationally operates the operation device thereby to perform adjusting the sound volume of a speaker, adjusting the temperature of an air conditioner, or controlling page-scrolling or the like on a display, if the vehicle has to start moving before the adjusted level reaches an intended level, the driver terminates such a rotational operation before the adjusted level reaches the intended level. The information processing device reflects the adjusted level at the time the rotational operation is terminated. This may result in a driving situation in which the sound volume of the speaker could not sufficiently be decreased and thus the sound volume is still large; a driving situation in which the temperature of the air conditioner could not sufficiently be increased and thus the temperature is still low; or a driving situation in which the driver drives while looking at a page in which necessary information is not shown.

This invention has been made to solve the problem as described above, and an object thereof is to avoid executing an operation unintended by the operator.

### Solution to Problem

An input control device according to the invention is an input control device for controlling an input device provided with: an operation device having multiple protrusions; a touch panel for detecting contact positions of the multiple protrusions and pressing forces of the multiple protrusions; and a display integrated with the touch panel, the input control device comprising: an operation determination unit for determining whether or not a rotational operation or a decision operation has been performed on the operation device, on a basis of at least one of a set of the contact positions of the multiple protrusions and a set of the pressing forces of the multiple protrusions, detected by the touch panel; a rotation amount storing unit for storing, when it is determined by the operation determination unit that the rotational operation has been performed, information of a rotation amount due to the rotational operation; and a control unit for controlling, when it is determined by the operation determination unit that the decision operation has been performed, a control target device by using the information of the rotation amount stored in the rotation amount storing unit.

### Advantageous Effects of Invention

According to the invention, when it is determined that the rotational operation has been performed on the operation device, the information of the rotation amount due to the rotational operation is stored, and then, when it is determined that the decision operation has been performed on the operation device, the control target device is controlled by using the information of the rotation amount stored in the rotation amount storing unit. Thus, the control target device is not controlled until the decision operation is performed, so that it is possible to avoid executing an operation unintended by the operator.

### BRIEF DESCRIPTION OF DRAWINGS

FIG. 1 is a block diagram showing a configuration example of an input system according to Embodiment 1.

FIG. 2 is a perspective view showing a configuration example of an input device according to Embodiment 1.

FIG. 3 is a plan view showing a configuration example of a back side of an operation device according to Embodiment 1.

FIG. 4 is a flowchart showing an example of operations of an input control device according to Embodiment 1.

FIG. 5 is a flowchart showing an example of operations of an input control device according to Embodiment 2.

FIG. 6 is a flowchart showing another example of operations of the input control device according to Embodiment 2.

FIG. 7 is a flowchart showing another example of operations of the input control device according to Embodiment 2.

FIG. 8 is a block diagram showing a configuration example of an input system according to Embodiment 3.

FIG. 9 is a flowchart showing an example of operations of an input control device according to Embodiment 3.

FIG. 10 is a diagram showing an example of notification information displayed on a display in Embodiment 3.

FIG. 11 is a perspective view showing a configuration example of an operation device according to Embodiment 4.

FIG. 12 is a perspective view showing a configuration example of an operation device according to Embodiment 5.

FIG. 13 is a diagram showing an example of display information displayed in a hollow portion of the operation device in Embodiment 5.

FIG. 14: FIG. 14A and FIG. 14B are diagrams each showing a hardware configuration example of the input control device according to each of the embodiments.

### DESCRIPTION OF EMBODIMENTS

Hereinafter, for illustrating the invention in more detail, embodiments for carrying out the invention will be described with reference to the accompanying drawings.

### Embodiment 1

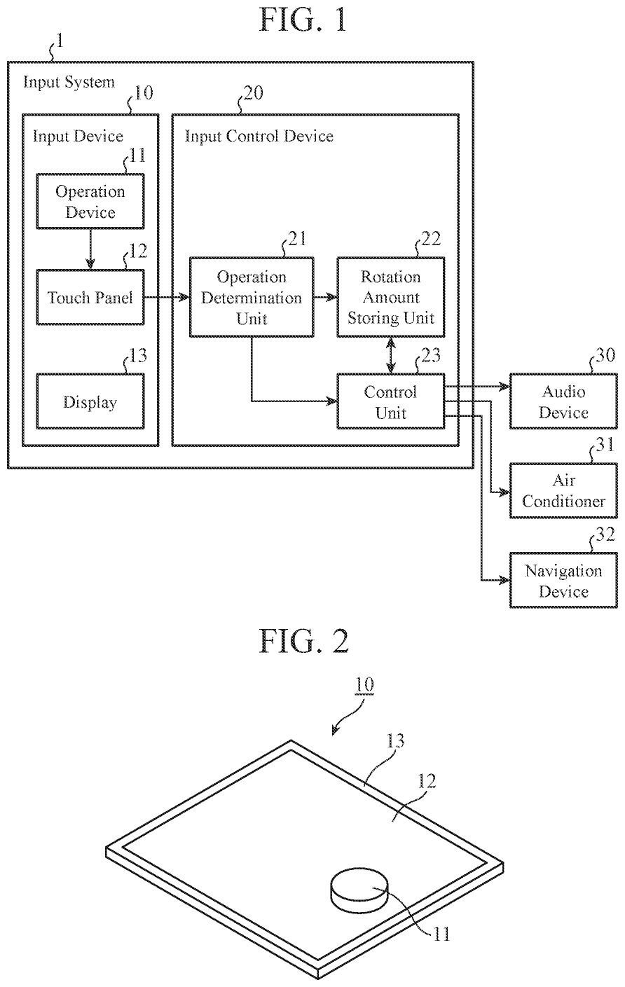

FIG. 1 is a block diagram showing a configuration example of an input system 1 according to Embodiment 1. The input system 1 includes an input device 10 and an input control device 20. The input system 1 is installed in a vehicle or the like, and receives an operation by an operator to thereby control, in response to the received operation, an operation of a control target device. The control target device may be any type of device if it is installed in a vehicle or the like. In FIG. 1, an audio device 30, an air conditioner 31 and a navigation device 32 are each exemplified as the control target device.

The input device 10 includes an operation device 11, a touch panel 12 and a display 13.

FIG. 2 is a perspective view showing a configuration example of the input device 10 according to Embodiment 1. The touch panel 12 is attached onto the screen of the display 13 such as a liquid-crystal display or the like, so that the display 13 and the touch panel 12 are integrated with each other. The touch panel 12 includes touch sensors and pressure sensors, and detects a contact position of an object and a pressing force by that object pressing the touch panel 12, and then outputs them to an operation determination unit 21. The object is the operation device 11, a finger of the operator or the like.

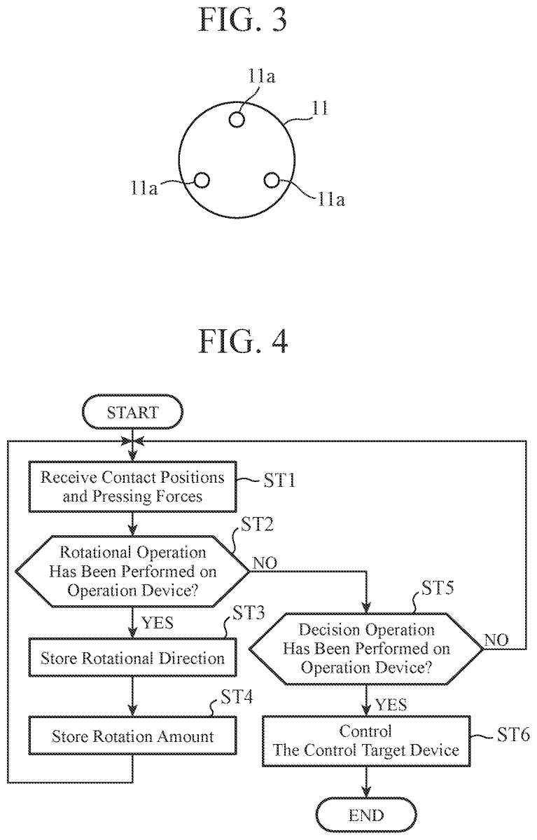

FIG. 3 is a plan view showing a configuration example of the back side of the operation device 11 according to Embodiment 1. The back side of the operation device 11 corresponds to a surface to be in contact with the touch panel 12. On the back side of the operation device 11, multiple protrusions 11a each made of a conductive material are formed. In this example of FIG. 3, three protrusions 11a are placed at constant intervals; however, the number of the protrusions 11a and placement positions thereof may be given freely. The operation device 11 is placed on the touch panel 12 configured integrally with the display 13, so that the three protrusions 11a in contact with the touch panel 12 are detected by the touch panel 12.

The input device 10 shown in FIG. 2 is placed, for example, between the driver's seat and the front passenger's seat in the vehicle. At the time of controlling the control target device such as the audio device 30 or the like, an occupant on the driver's seat or the front passenger's seat performs: an operation of moving the operation device 11 on the touch panel 12; an operation of rotating the operation device 11 at its position; an operation of pressing the operation device 11 against the touch panel 12; or the like. Note that the input device 10 may be placed at any given position in the vehicle, and the operation device 11 may be operated by an occupant on any one of seats.

In Embodiment 1, the driver is assumed to be the operator who operates the operation device 11. The driver selects the control target device subject to operation, from among the audio device 30, the air conditioner 31 and the navigation device 32, by, for example, operating the operation device 11. Then, in the case of decreasing the sound volume of the audio device 30, the driver rotates the operation device 11 counterclockwise, and in the case of increasing the sound volume, the driver rotates the operation device 11 clockwise. Note that an adjustment amount for the sound volume is proportional to the rotation amount of the operation device 11. In the case of decreasing the temperature of the air conditioner 31, the driver rotates the operation device 11 counterclockwise, and in the case of increasing the temperature, the driver rotates the operation device 11 clockwise. Note that an adjustment amount for the temperature is proportional to the rotation amount of the operation device 11. In the case of scrolling down the page displayed by the navigation device 32, the driver rotates the operation device 11 counterclockwise, and in the case of scrolling up the page, the driver rotates the operation device 11 clockwise. Note that a page scroll amount is proportional to the rotation amount of the operation device 11.

The input control device 20 serves to control the input device 10 and includes the operation determination unit 21, a rotation amount storing unit 22 and a control unit 23.

The operation determination unit 21 determines whether or not a rotational operation or a decision operation has been performed on the operation device 11, on the basis of at least either a set of the contact positions of the three protrusions 11a or a set of the pressing forces of the three protrusions 11a, detected by the touch panel 12. Specific examples of how to make such a determination will be described later. The operation determination unit 21, when having determined that a rotational operation has been performed on the operation device 11, outputs information of the rotational direction and the rotation amount of the operation device 11, to the rotation amount storing unit 22. The operation determination unit 21, when having determined that a decision operation has been performed on the operation device 11, outputs such a determination result to the control unit 23.

The operation determination unit 21 calculates movement trajectories of the three protrusions 11a, on the basis of temporal changes in the contact positions of the three protrusions 11a detected by the touch panel 12. Then, when the movement trajectories show arc-like shapes, the operation determination unit 21 determines that a rotational operation has been performed on the operation device 11. Further, the operation determination unit 21 calculates the rotational direction and the rotation amount of the operation device 11 from the calculated movement trajectories.

Further, when the operation device 11 presses the touch panel 12, the operation determination unit 21 determines that the decision operation has been performed.

Specifically, when all of the pressing forces of the three protrusions 11a are each equal to or more than a threshold value, the operation determination unit 21 determines that the operation device 11 presses the touch panel 12, namely, the decision operation has been performed by the driver. It is assumed that the threshold value is given beforehand to the operation determination unit 21. This makes it possible for the driver to perform the decision operation only by pressing the operation device 11 against the touch panel 12, without releasing his/her hand from the operation device 11.

Instead, the operation determination unit 21 may determine that the decision operation has been performed, when an average value of all of the pressing forces of the three protrusions 11a is equal to or more than a threshold value. This makes it possible for the driver to perform the decision operation only by pressing the operation device 11 against the touch panel 12, without releasing his/her hand from the operation device 11. Note that, at the time the driver is going to operate the operation device 11 positioned nearer to the front passenger's seat, on the touch panel 12, it is conceivable that the back side of the operation device 11 is placed not in parallel to the surface of the touch panel 12 but in an inclined state thereto. In that case, a possibility may arise that the pressing force of one of the protrusions 11a becomes larger while the pressing forces of the other two protrusions 11a become smaller. In this case, if the average value of the three pressing forces is equal to or more than the threshold value, the operation is determined to be the decision operation, so that it is possible to prevent the ability of sensing the decision operation from being degraded.

Instead, the operation determination unit 21 may determine that the decision operation has been performed, when the pressing force by at least one protrusion 11a among the three protrusions 11a is equal to or more than a threshold value. For example, when the maximum value of the pressing forces of the three protrusions 11a is equal to or more than a threshold value, the operation determination unit 21 determines that the decision operation has been performed. As described above, when the back side of the operation device 11 is placed not in parallel to the surface of the touch panel 12 but in an inclined state thereto, a possibility may arise that the pressing force of one of the protrusions 11a becomes larger while the pressing forces of the other two protrusions 11a become smaller. In this case, if at least one of the three pressing forces is equal to or more than the threshold value, the operation is determined to be the decision operation, so that it is possible to prevent the ability of sensing the decision operation from being degraded.

When the rotational operation is performed on the operation device 11, the rotation amount storing unit 22 receives from the operation determination unit 21, the information of the rotational direction and the rotation amount of the operation device 11, and stores it.

When the decision operation is performed on the operation device 11, the control unit 23 receives the determination result from the operation determination unit 21. Then, the control unit 23 reads out from the rotation amount storing unit 22, the information of the rotational direction and the rotation amount of the operation device 11 due to the rotational operation before the execution of the decision operation. On the basis of the rotational direction and the rotation amount read out from the rotation amount storing unit 22, the control unit 23 generates control information for controlling the control target device such as the audio device 30 or the like, and outputs it to the control target device. Note that it is assumed that the control unit 23 recognizes which one of the audio device 30, the air conditioner 31 and the navigation device 32, is the control target device subject to operation.

Specifically, at the time of adjusting the sound volume of the audio device 30, the control unit 23 determines to increase or decrease the sound volume, in response to whether the rotational direction read out from the rotation amount storing unit 22 is clockwise or counterclockwise. Further, the control unit 23 calculates the adjustment amount for the sound volume that is proportional to the rotation amount read out from the rotation amount storing unit 22. Then, the control unit 23 generates the control information indicative of whether to increase or decrease the sound volume and indicative of the adjustment amount for the sound volume, and outputs it to the audio device 30.

At the time of adjusting the temperature of the air conditioner 31, the control unit 23 determines to increase or decrease the temperature, in response to whether the rotational direction read out from the rotation amount storing unit 22 is clockwise or counter-clockwise. Further, the control unit 23 calculates the adjustment amount for the temperature that is proportional to the rotation amount read out from the rotation amount storing unit 22. Then, the control unit 23 generates the control information indicative of whether to increase or decrease the temperature and indicative of the adjustment amount for the temperature, and outputs it to the air conditioner 31.

At the time of page-scrolling on the navigation device 32, the control unit 23 determines to scroll up or scroll down the page, in response to whether the rotational direction read out from the rotation amount storing unit 22 is clockwise or counterclockwise. Further, the control unit 23 calculates the page scroll amount that is proportional to the rotation amount read out from the rotation amount storing unit 22. Then, the control unit 23 generates the control information indicative of whether to scroll up or scroll down the page and indicative of the page scroll amount, and outputs it to the navigation device 32.

The control target device, such as the audio device 30 or the like, operates according to the control information received from the control unit 23. For example, the audio device 30, when having received the control information whose content is “Increase the sound volume by two levels”, increases the sound volume of an unshown speaker by two levels. For further example, the air conditioner 31, when having received the control information whose content is “Increase the temperature by two degrees”, increases the preset temperature by two degrees. For further example, the navigation device 32, when having received the control information whose content is “Scroll down the page by two lines”, scrolls down the displayed page by two lines.

It is noted that, in Embodiment 1, the input control device 20 controls the control target device on the basis of the rotational direction and the rotation amount; however, when the control target device is to be controlled only on the basis of the rotation amount, the input control device 20 just has to control the control target device only on the basis of the rotation amount.

Next, operations of the input system 1 according to Embodiment 1 will be described.

FIG. 4 is a flowchart showing an example of operations of the input control device 20 according to Embodiment 1. The touch panel 12 detects, at every sampling period, the contact positions of the three protrusions 11a of the operation device 11 and the pressing forces thereof, and outputs them to the operation determination unit 21. The input control device 20 repeats the operations shown in the flowchart of FIG. 4 at every sampling period.

Here, a case is assumed where the input system 1 performs adjusting the sound volume of the audio device 30.

In Step ST1, the operation determination unit 21 receives information of the contact positions of the three protrusions 11a and the pressing forces thereof, detected by the touch panel 12.

In Step ST2, on the basis of the contact positions of the three protrusions 11a received in the previous Step ST1 and the contact positions of the three protrusions 11a received in the latest Step ST1, the operation determination unit 21 calculates the movement trajectories of the three protrusions 11a, to thereby determine whether or not a rotational operation has been performed on the operation device 11. The operation determination unit 21, when having determined that a rotational operation has been performed on the operation device 11 (Step ST2 “YES”), proceeds to Step ST3, and otherwise (Step ST2 “NO”) proceeds to Step ST5. Note that, at the first time of the repetitive operations shown in the flowchart of FIG. 4, there is provided only one set of information about the contact positions of the three protrusions 11a, and thus movement trajectories of the three protrusions 11a cannot be calculated (Step ST2 “NO”), so that the operation determination unit 21 proceeds to Step ST5.

In Step ST3, the operation determination unit 21 causes the rotation amount storing unit 22 to store the rotational direction of the operation device 11 that is based on the movement trajectories calculated in Step ST2. Information of the rotational direction stored in the rotation amount storing unit 22 is time-series data.

In Step ST4, the operation determination unit 21 causes the rotation amount storing unit 22 to store the rotation amount of the operation device 11 that is based on the movement trajectories calculated in Step ST2, in a state linked to the rotational direction given in Step ST3. Information of the rotation amount stored in the rotation amount storing unit 22 is time-series data. Then, the operation determination unit 21 returns to Step ST1.

In Step ST5, the operation determination unit 21 makes comparison between the pressing forces of the three protrusions 11a received in Step ST1, and a threshold value, to thereby determine whether or not a decision operation has been performed on the operation device 11. The operation determination unit 21, when having determined that a decision operation has been performed on the operation device 11 (Step ST5 “YES”), proceeds to Step ST6, and otherwise (Step ST5 “NO”) returns to Step ST1.

In Step ST6, the operation determination unit 21 outputs the determination result indicating the decision operation, to the control unit 23. The control unit 23 reads out the information of the rotational direction and the rotation amount stored in the rotation amount storing unit 22 to thereby generate control information for adjusting the sound volume of the audio device 30, and outputs it to the audio device 30. Note that the control unit 23 will delete the information of the rotational direction and the rotation amount that is no longer required after generation of the control information, from the rotation amount storing unit 22.

As described above, the input control device according to Embodiment 1 includes the operation determination unit 21, the rotation amount storing unit 22 and the control unit 23. The operation determination unit 21 determines whether or not a rotational operation or a decision operation has been performed on the operation device 11, on the basis of at least either a set of the contact positions of the multiple protrusions 11a or a set of the pressing forces of the multiple protrusions 11a, detected by the touch panel 12. The rotation amount storing unit 22 stores, when it is determined by the operation determination unit 21 that the rotational operation has been performed, the information of the rotation amount due to the rotational operation. The control unit 23 controls, when it is determined by the operation determination unit 21 that the decision operation has been performed, the control target device by using the information of the rotation amount stored in the rotation amount storing unit 22. This configuration makes it possible for the input control device 20 not to control the control target device until the decision operation is performed, to thereby avoid executing an operation unintended by the operator.

For example, during waiting at a traffic light, when the driver of the vehicle operates the operation device 11 in order to adjust the sound volume of the audio device 30, to adjust the temperature of the air conditioner 31, or to perform page-scrolling or the like on the navigation device 32, a situation may occur in which the vehicle has to start moving before the adjusted level reaches the intended level. In this case, the input control device 20 according to Embodiment 1 does not reflect the adjusted level unwanted by the driver, in the audio device 30 or the like, so that the driver can drive with no stress.

Further, the operation determination unit 21 in Embodiment 1 determines that the decision operation has been performed, when the operation device 11 presses the touch panel 12. This configuration makes it possible for the operator to perform the decision operation only by pressing the operation device 11 against the touch panel 12, without releasing his/her hand from the operation device 11.

It is noted that, when the driver, after rotating the operation device 11 in one direction while twisting his/her wrist to the limit, wants to continue operating the operation device 11 rotationally further in the same direction, the driver has to move the wrist back to the original position and then to rotate again the operation device 11 in the one direction. On this occasion, if the driver performs such a rotational operation without releasing the hand from the operation device 11 and without releasing the operation device 11 from the touch panel 12, the input control device 20 has to eliminate the movement of the wrist back to the original position, from the rotational operation. In this case, in Step ST6 in FIG. 4, the control unit 23 accumulates, out of the information of the rotational directions and the rotation amounts stored in the rotation amount storing unit 22, only information of the rotation amounts in the rotational direction that is same as the rotational direction at the time the operational operation for the operation device 11 has started, to thereby determine the adjustment amount for the control target device. This configuration makes it possible to avoid reflecting in controlling the control target device, a rotational operation unintended by the operator that is due to the movement of the wrist back to the original position.

### Embodiment 2

The input control device 20 according to Embodiment 2 deletes, when a cancelling operation has been performed on the operation device 11, the information stored in the rotation amount storing unit 22, to thereby make a next rotational operation allowable.

The configuration of the input system 1 according to Embodiment 2 is graphically identical to the configuration shown in FIG. 1 to FIG. 3 of Embodiment 1, so that FIG. 1 to FIG. 3 will also be employed below.

The operation determination unit 21 in Embodiment 2 determines whether or not a cancelling operation has been performed on the operation device 11, on the basis of at least one of a set of the contact positions of the three protrusions 11a and a set of the pressing forces of the three protrusions 11a, detected by the touch panel 12.

Specifically, the operation determination unit 21 determines that the cancelling operation has been performed, when no operation is performed on the operation device 11 within a predetermined period of time (for example, 10 seconds). For example, when the predetermined period of time has elapsed from a time point at which the operation device 11 has been released from the touch panel 12, the operation determination unit 21 determines that the cancelling operation has been performed. For further example, when the positions of the three protrusions 11a on the touch panel 12 do not change for the predetermined period of time, the operation determination unit 21 determines that the cancelling operation has been performed. When the driver improperly performs a rotational operation on the operation device 11 during stopping or immediately before starting of the vehicle, even if the driver does not additionally operate the operation device 11, such an improper rotational operation will be cancelled after the elapse of the predetermined period of time, so that the driver can concentrate on driving.

Instead, on the basis of the information on the rotational directions and rotation amounts stored in the rotation amount storing unit 22, the operation determination unit 21 may determine that the cancelling operation has been performed, when, within a predetermined period of time (for example, 10 seconds), the operation device 11 is rotated clockwise and counterclockwise alternately predetermined times (for example, three times clockwise and three times counterclockwise, i.e. a total of six times) or more, by a rotation amount of more than, or not more than a predetermined rotation amount. For example, the operation determination unit 21 regards as the predetermined rotation amount, a rotation amount in the rotational direction at the time the driver twisted the wrist once to start the rotational operation for the operation device 11; and determines that the cancelling operation has been performed, when the operation device 11 is rotated clockwise and counterclockwise alternately predetermined times or more in such a manner that a rotation amount in the inverse direction is larger than the predetermined rotation amount. For further example, the operation determination unit 21 regards as the predetermined rotation amount, a rotation amount (for example, a rotation angle of 40 degrees) that is larger than a rotation amount (for example, a rotation angle of 30 degrees) that the driver can get by twisting the wrist once to rotate the operation device 11; and determines that the cancelling operation has been performed, when the operation device 11 is rotated clockwise and counter-clockwise alternately predetermined times or more, by a rotation amount of 40 degrees or more. For further example, the operation determination unit 21 regards as the predetermined rotation amount, a rotation amount (for example, a rotation angle of 20 degrees) that is smaller than a rotation amount (for example, a rotation angle of 30 degrees) that the driver can get by twisting the wrist once to rotate the operation device 11; and determines that the cancelling operation has been performed, when the operation device 11 is rotated clockwise and counter-clockwise alternately predetermined times or more, by a rotation amount of 20 degrees or less. The driver can perform the cancelling operation without releasing the hand from the operation device 11.

Instead, on the basis of the pressing forces of the three protrusions 11a detected by the touch panel 12, the operation determination unit 21 may determine that the cancelling operation has been performed, when, within a predetermined period of time (for example, 10 seconds), the operation device 11 presses the touch panel 12 predetermined times (for example, three times) or more, consecutively. The driver can perform the cancelling operation without releasing the hand from the operation device 11.

When it is determined by the operation determination unit 21 that a cancelling operation has been performed on the operation device 11, the rotation amount storing unit 22 deletes the information of the rotational direction and the rotation amount stored therein.

Next, examples of operations of the input system 1 according to Embodiment 2 will be described.

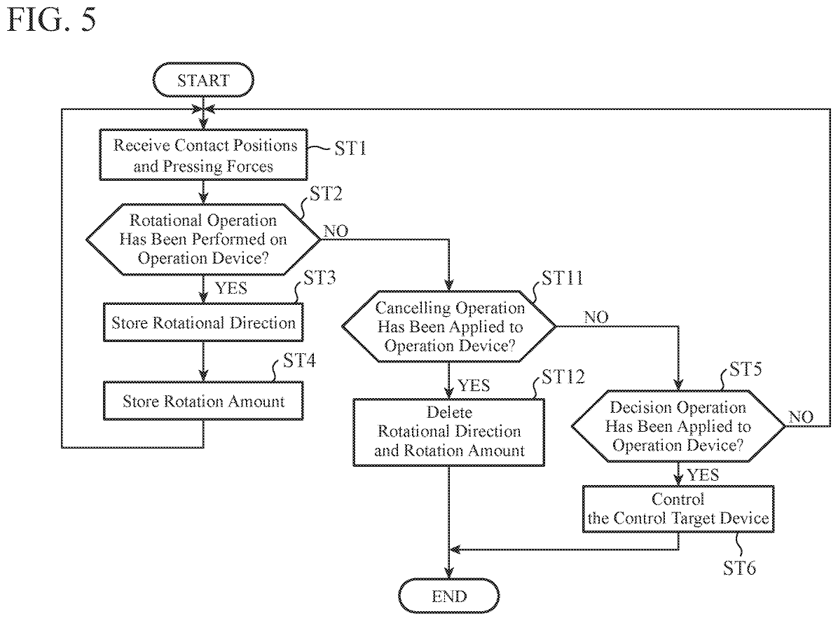

FIG. 5 is a flowchart showing an example of operations of the input control device 20 according to Embodiment 2. The flowchart of FIG. 5 shows exemplary operations of the input control device 20 in the case where the cancelling operation is an operation of causing the operation device 11 to be released from the touch panel 12 for a predetermined period of time. The touch panel 12 detects, at every sampling period, the contact positions of the three protrusions 11a of the operation device 11 and the pressing forces thereof, and outputs them to the operation determination unit 21. The input control device 20 repeats the operations shown in the flowchart of FIG. 5 at every sampling period. Note that operations in Steps ST1 to ST6 in FIG. 5 are the same as those in Steps ST1 to ST6 in FIG. 4, so that description thereof will be omitted.

When it is determined in Step ST2 that no rotational operation has been performed (Step ST2 “NO”), the operation determination unit 21 determines in Step ST11 whether or not a cancelling operation has been performed on the operation device 11. The operation determination unit 21, when having determined that a cancelling operation has been performed on the operation device 11 (Step ST11 “YES”), proceeds to Step ST12, and otherwise (Step ST11 “NO”) proceeds to Step ST5.

When having received information indicating no contact position and no pressing force from the touch panel 12 in Step ST2, the operation determination unit 21 returns back to Step ST1 through Step ST2 “NO”, Step ST11 “NO” and Step ST5 “NO”. Thereafter, when the operation determination unit 21 continues receiving information indicating no contact position and no pressing force until a predetermined period of time elapses, it determines that the cancelling operation has been performed (Step ST11 “YES”).

In Step ST12, the operation determination unit 21 deletes the information of the rotational direction and the rotation amount stored in the rotation amount storing unit 22.

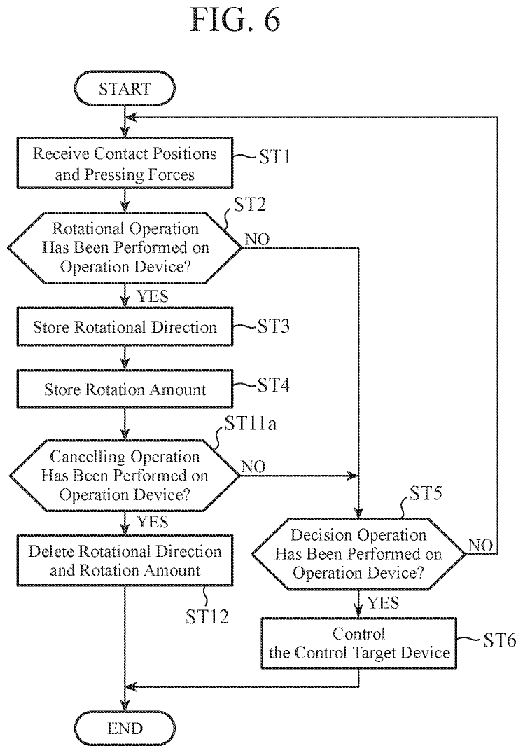

FIG. 6 is a flowchart showing another example of operations of the input control device 20 according to Embodiment 2. The flowchart of FIG. 6 shows exemplary operations of the input control device 20 in the case where the cancelling operation is an operation of rotating, within a predetermined period of time, the operation device 11 clockwise and counterclockwise alternately predetermined times or more, by a rotation amount of more than, or not more than a predetermined rotation amount. The touch panel 12 detects, at every sampling period, the contact positions of the three protrusions 11a of the operation device 11 and the pressing forces thereof, and outputs them to the operation determination unit 21. The input control device 20 repeats the operations shown in the flowchart of FIG. 6 at every sampling period. Note that operations in Steps ST1 to ST6 in FIG. 6 are the same as those in Steps ST1 to ST6 in FIG. 4, so that description thereof will be omitted.

After the information of the rotational direction and the rotation amount are stored in the rotation amount storing unit 22 in Step ST3 and Step ST4, the operation determination unit 21 determines in Step ST11a whether or not a cancelling operation has been performed on the operation device 11, on the basis of time-series data of rotational directions and rotation amounts stored in the rotation amount storing unit 22. The operation determination unit 21, when having determined that a cancelling operation has been performed on the operation device 11 (Step ST11a “YES”), proceeds to Step ST12, and otherwise (Step ST11a “NO”) proceeds to Step ST5.

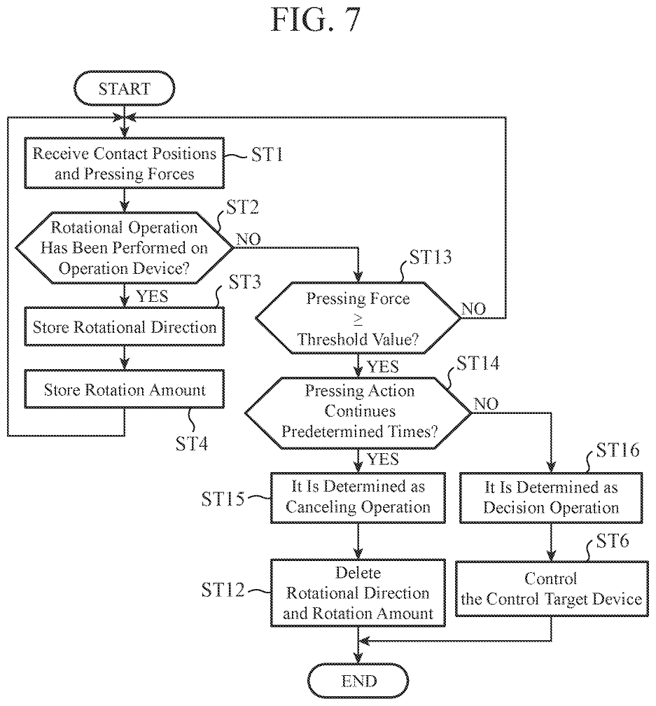

FIG. 7 is a flowchart showing another example of operations of the input control device 20 according to Embodiment 2. The flowchart of FIG. 7 shows exemplary operations of the input control device 20 in the case where the cancelling operation is an operation of causing the operation device 11 to press the touch panel 12 predetermined times or more, consecutively. The touch panel 12 detects, at every sampling period, the contact positions of the three protrusions 11a of the operation device 11 and the pressing forces thereof, and outputs them to the operation determination unit 21. The input control device 20 repeats the operations shown in the flowchart of FIG. 7 at every sampling period. Note that operations in Steps ST1 to ST4, and ST6 in FIG. 7 are the same as those in Steps ST1 to ST4, and ST6 in FIG. 4, so that description thereof will be omitted.

In Step ST13, the operation determination unit 21 makes comparison between the pressing forces of the three protrusions 11a received from the touch panel 12 in Step ST1, and a threshold value. Note that, like in Embodiment 1, the operation determination unit 21 may compare all of the pressing forces of the three protrusions 11a each with a threshold value, may compare an average value of the pressing forces of the three protrusions 11a with a threshold value, or may compare at least one of the pressing forces of the three protrusions 11a with a threshold value. When such a pressing force(s) is equal to or more than a threshold value (Step ST13 “YES”), the operation determination unit 21 determines that the operation device 11 presses the touch panel 12, and then proceeds to Step ST14, and otherwise (Step ST13 “NO”) returns to Step ST1.

In Step ST14, when the determination result indicating that the operation device 11 presses the touch panel 12, continues predetermined times or more within a predetermined period of time (Step ST14 “YES”) , the operation determination unit 21 proceeds to Step ST15, and, when that determination result is once within the predetermined period of time (Step ST14 “NO”) , proceeds to Step ST16.

In Step ST15, the operation determination unit 21 determines that a cancelling operation has been performed on the operation deice 11.

Meanwhile, in Step ST16, the operation determination unit 21 determines that a decision operation has been performed on the operation deice 11.

As described above, the operation determination unit 21 in Embodiment 2 determines whether or not a cancelling operation has been performed on the operation device 11, on the basis of at least either a set of the contact positions of the multiple protrusions 11a or a set of the pressing forces of the multiple protrusions 11a, detected by the touch panel 12. When it is determined by the operation determination unit 21 that the cancelling operation has been performed, the rotation amount storing unit 22 deletes the information of the rotation amount stored therein. This configuration makes it possible for the operator, when he/she improperly performed a rotational operation, to perform again a rotational operation immediately.

### Embodiment 3

The input control device 20 according to Embodiment 3 notifies the operator of the content of an operation.

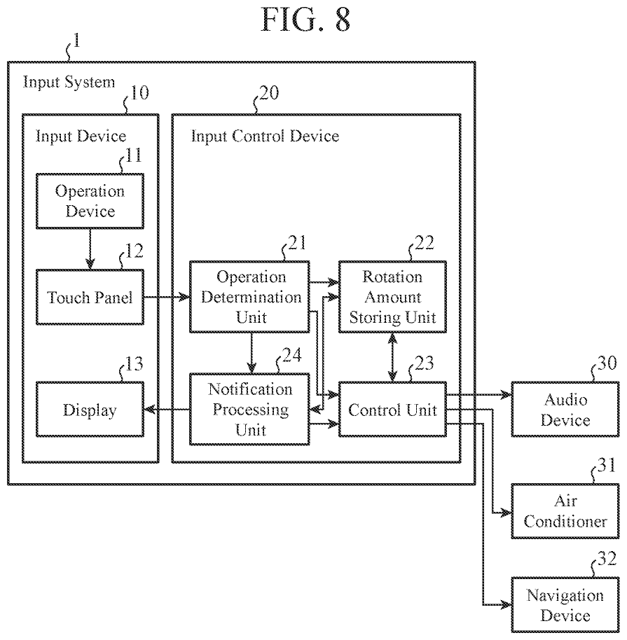

FIG. 8 is a block diagram showing a configuration example of an input system 1 according to Embodiment 3. The configuration of the input system 1 according to Embodiment 3 results from addition of a notification processing unit 24 to the input system 1 of Embodiment 1 shown in FIG. 1. In FIG. 8, for the parts same as or equivalent to those in FIG. 1, the same numerals are given, so that description thereof will be omitted.

The notification processing unit 24 receives the determination result from the operation determination unit 21. Then, the notification processing unit 24 generates notification information for notifying the operator of the content of the operation determined by the operation determination unit 21, and outputs it to at least one of the display 13 and the control unit 23.

For example, the notification processing unit 24 generates notification information for voice output, and outputs it through the control unit 23 to the audio device 30. The audio device 30 outputs the notification information as a voice through an unshown speaker.

For further example, the notification processing unit 24 generates notification information for display, and outputs it to the display 13. The display 13 displays the notification information. Instead, the notification processing unit 24 outputs the notification information for display, to the navigation device 32 through the control unit 23. The navigation device 32 displays the notification information. Note that a device for displaying the notification information is not limited to the display 13 or the navigation device 32, and may be an unshown head-up display or the like. In the case where the notification information is displayed on the head-up display or outputted as a voice, the driver can operate the operation device 11 without moving his/her eye's and while facing forward.

Next, operations of the input system 1 according to Embodiment 3 will be described.

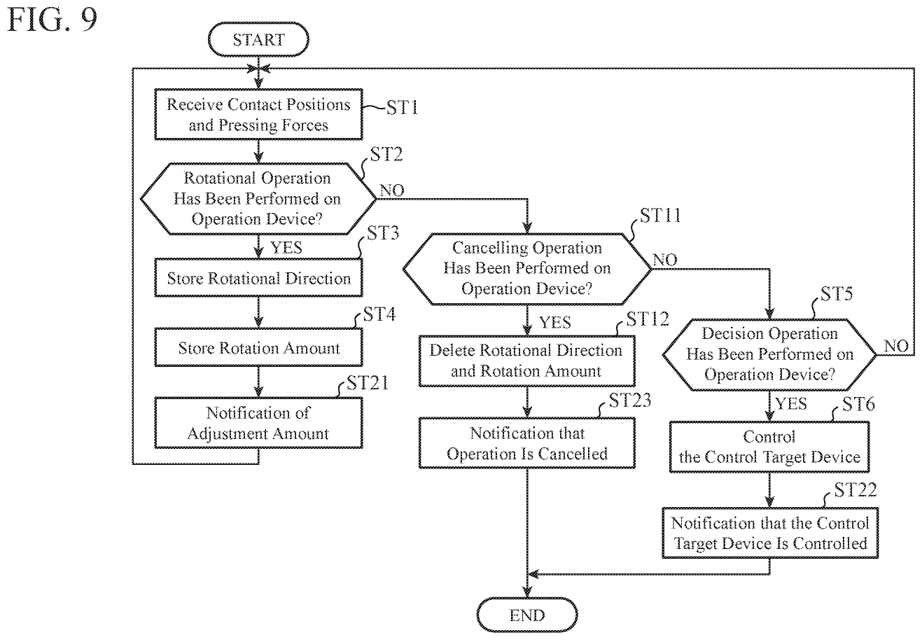

FIG. 9 is a flowchart showing an example of operations of the input control device 20 according to Embodiment 3. Here, an example of operations of the notification processing unit 24 will be described on the basis of the flowchart of FIG. 5 in Embodiment 2. Operations in Steps ST1 to ST6 and Steps ST11, ST12 in FIG. 9 are the same as those in Steps ST1 to ST6 and Steps ST11, ST12 in FIG. 5, so that description thereof will be omitted.

Here, a case is assumed where the input system 1 performs adjusting the sound volume of the audio device 30.

When the operation device 11 is rotationally operated, in Step ST21, the notification processing unit 24 reads out the information of the rotation amount stored in the rotation amount storing unit 22, to thereby calculate an adjustment amount for the sound volume of the audio device 30. Then, the notification processing unit 24 generates notification information for giving notification of the adjustment amount for the sound volume, and outputs it to the display 13, the audio device 30, the navigation device 32 or the like. This configuration makes it possible for the driver to recognize a current adjustment amount for the control target device.

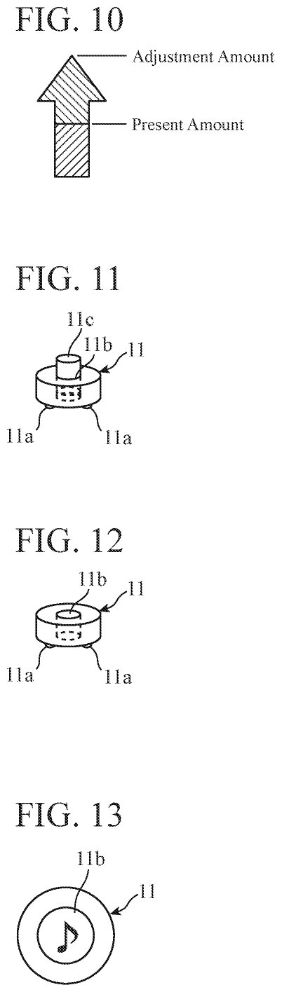

For example, in Step ST21, the notification processing unit 24 generates notification information for displaying, or outputting as a voice, an adjustment amount of “+2” for the sound volume. For further example, the notification processing unit 24 generates notification information for displaying or outputting as a voice, that “When a decision operation is performed, the sound volume increases by +2”. For further example, the notification processing unit 24 generates notification information for displaying or outputting as a voice, that “The adjustment amount for the sound volume is now +2”. For further example, the notification processing unit 24 generates notification information for displaying a graphic symbol of the present amount and the adjustment amount as shown in FIG. 10. FIG. 10 is a graphic symbol showing an example of notification information displayed on the display 13 in Embodiment 3.

When a decision operation is performed on the operation device 11, in Step ST22, the notification processing unit 24 generates notification information for giving notification that the control target device is controlled, and outputs it to the display 13, the audio device 30, the navigation device 32 or the like. This configuration makes it possible for the driver to recognize that he/she has successfully decided the rotational operation.

For example, in Step ST22, the notification processing unit 24 generates notification information for displaying or outputting as a voice, that “The operation is reflected”. For further example, the notification processing unit 24 generates notification information for displaying or outputting as a voice, a term “Decision”.

When a cancelling operation is performed on the operation device 11, in Step ST23, the notification processing unit 24 generates notification information for giving notification that the rotational operation is cancelled, and outputs it to the display 13, the audio device 30, the navigation deice 32 or the like. This configuration makes it possible for the driver to recognize that he/she has successfully cancelled the rotational operation.

For example, in Step ST23, the notification processing unit 24 generates notification information for displaying, or outputting as a voice, that “The operation is cancelled”. For further example, the notification processing unit 24 generates notification information for displaying, or outputting as a voice, a term “Cancel”.

As described above, the input control device 20 according to Embodiment 3 includes the notification processing unit 24. The notification processing unit 24 generates notification information for notifying the operator of the content of the operation determined by the operation determination unit 21. This configuration makes it possible for the operator to recognize the content of the operation that he/she has performed on the operation device 11.

### Embodiment 4

In Embodiment 4, one of the multiple protrusions 11a that the operation device 11 has, is formed as a push button.

FIG. 11 is a perspective view showing a configuration example of the operation device 11 according to Embodiment 4. At the center of the operation device 11, a hollow portion 11b is created that penetrates through the operation device 11 from front to back. In the hollow portion 11b, a pushbutton 11c made of a conductive material is placed. When the push button 11c is pressed down inside the hollow portion 11b by an operator, it makes contact with the touch panel 12 and is thus detected by the touch panel 12. After completion of pressing down by the operator, the push button 11c moves away from the touch panel 12 to return to its original position.

Note that the configuration of the input control device 20 according to Embodiment 4 is graphically identical to the configuration shown in FIG. 1 of Embodiment 1, so that FIG. 1 will also be employed below.

The operation determination unit 21 in Embodiment 4 calculates the position of the push button 11c on the touch panel 12, on the basis of the contact positions of the three protrusions 11a detected by the touch panel 12. Further, the operation determination unit 21 determines whether or not the push button 11c makes contact with the touch panel 12, on the basis of the contact positions detected by the touch panel 12. When having determined that the push button 11c makes contact with the touch panel 12, the operation determination unit 21 determines that a decision operation has been performed on the operation device 11.

Instead, for example, the operation determination unit 21 may determine whether or not the push button 11c presses the touch panel 12 with a pressing force equal to or more than a threshold value, on the basis of the contact positions and the pressing forces detected by the touch panel 12. When having determined that the push button 11c presses the touch panel 12, the operation determination unit 21 determines that a decision operation has been performed on the operation device 11.

As described above, in the operation device 11 according to Embodiment 4, one of the multiple protrusions 11a is formed as the push button 11c. The operation determination unit 21 determines that the decision operation has been performed, when the push button 11c makes contact with the touch panel 12 or presses the touch panel 12. This configuration makes it possible for the operator to perform the decision operation without releasing the hand from the operation device 11, only by pressing down the push button 11c. Further, in the case where the decision operation is an operation of causing the push button 11c to make contact with the touch panel 12, since the touch panel 12 is not required to have the pressure sensors, it is possible to achieve cost reduction.

It is noted that, in Embodiment 2 or Embodiment 3, the operation device 11 in Embodiment 4 may instead be used. In this case, like in Embodiment 2, the operation determination unit 21 determines the cancelling operation for the operation device 11, on the basis of at least either a set of the contact positions of the three protrusions 11a or a set of the pressing forces of the three protrusions 11a.

### Embodiment 5

In Embodiment 5, an operation device 11 has, at the center thereof, a hollow portion that allows the touch panel 12 to be exposed therethrough.

FIG. 12 is a perspective view showing a configuration example of the operation device 11 according to Embodiment 5. At the center of the operation device 11, a hollow portion 11b is created that penetrates through the operation device 11 from front to back. The hollow portion 11b allows the touch panel 12 to be exposed therethrough.

Note that the configuration of the input control device 20 according to Embodiment 5 is graphically identical to the configuration shown in FIG. 8 of Embodiment 3, so that FIG. 8 will also be employed below.

The operation determination unit 21 in Embodiment 5 calculates an area on the touch panel 12 corresponding to the hollow portion 11b, on the basis of the contact positions of the three protrusions 11a detected by the touch panel 12. Further, the operation determination unit 21 determines whether or not an object makes contact with the area on the touch panel 12 corresponding to the hollow portion 11b, on the basis of the contact positions detected by the touch panel 12. The object is a finger of the driver, or the like. When having determined that the object makes contact with the area corresponding to the hollow portion 11b, the operation determination unit 21 determines that a decision operation has been performed on the operation device 11.

Instead, for example, the operation determination unit 21 may determine whether or not the object presses the area on the touch panel 12 corresponding to the hollow portion 11b with a pressing force equal to or more than a threshold value, on the basis of the contact positions and the pressing forces detected by the touch panel 12. When having determined that the object presses the area corresponding to the hollow portion 11b, the operation determination unit 21 determines that a decision operation has been performed on the operation device 11.

The notification processing unit 24 in Embodiment 5 receives information indicating the location of the area on the display 13 configured integrally with the touch panel 12, corresponding to the hollow portion 11b, from the operation determination unit 21. Then, the notification processing unit 24 generates display information for displaying in the area on the display 13 corresponding to the hollow portion 11b, an image or the like that represents the control target device subject to operation, and outputs it to the display 13.

FIG. 13 is a diagram showing an example of display information displayed in the hollow portion 11b of the operation device 11 in Embodiment 5. In FIG. 13, a case is assumed where the input system 1 performs adjusting the sound volume of the audio device 30. In this case, the notification processing unit 24 displays an image of a musical note on the display 13 in the hollow portion 11b. Upon seeing the image displayed in the hollow portion 11b, the driver can recognize that the sound volume of the audio device 30 is now adjustable by the rotational operation of the operation device 11.

As described above, the operation device 11 according to Embodiment 5 has, at the center thereof, the hollow portion 11b that allows the touch panel 12 to be exposed therethrough. The operation determination unit 21 determines that the decision operation has been performed, when it detects that an object makes contact with, or presses the touch panel 12 through the hollow portion 11b. This configuration makes it possible for the operator to perform the decision operation without releasing the hand from the operation device 11, only by touching or pressing the touch panel 12 through the hollow portion 11b. Further, in the case where the decision operation is an operation of touching the touch panel 12 through the hollow portion 11b, since the touch panel 12 is not required to have the pressure sensors, it is possible to achieve cost reduction.

It is noted that, in Embodiment 2 or Embodiment 3, the operation device 11 in Embodiment 5 may instead be used. In this case, like in Embodiment 2, the operation determination unit 21 determines the cancelling operation for the operation device 11, on the basis of at least one of a set of the contact positions of the three protrusions 11a and a set of the pressing forces of the three protrusions 11a.

Lastly, description will be made about hardware configurations of the input control devices 20 according to the respective embodiments.

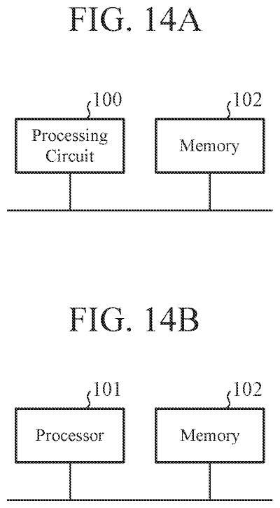

FIG. 14A and FIG. 14B are diagrams each showing a hardware configuration example of the input control device 20 according to each of the embodiments. The rotation amount storing unit 22 in the input control unit 20 is implemented by a memory 102. The functions of the operation determination unit 21, the control unit 23 and the notification processing unit 24 in the input control device 20 are implemented by a processing circuit. Namely, the input control device 20 includes the processing circuit for implementing the above functions. The processing circuit may be a processing circuit 100 as dedicated hardware, or may be a processor 101 which executes programs stored in the memory 102.

When the processing circuit is dedicated hardware as shown in FIG. 14A, what corresponds to the processing circuit 100 is, for example, a single circuit, a composite circuit, a programmed processor, a parallel-programmed processor, an ASIC (Application Specific Integrated Circuit), an FPGA (Field Programmable Gate Array) or any combination thereof. The functions of the operation determination unit 21, the control unit 23 and the notification processing unit 24 may be implemented by multiple processing circuits 100, or the functions of the respective units may be implemented collectively by one processing circuit 100.

When the processing circuit is the processor 101 as shown in FIG. 14B, the functions of the operation determination unit 21, the control unit 23 and the notification processing unit 24 are implemented by software, firmware or a combination of software and firmware. The software and the firmware are each written as a program(s) and stored in the memory 102. The processor 101 reads out and executes programs stored in the memory 102 to thereby implement the functions of the respective units. Namely, the input control device 20 is provided with the memory 102 for storing the programs by which, when they are executed by the processor 101, the steps shown in the flowcharts of FIG. 4 and the like are eventually executed. Further, it can also be said that these programs are programs for causing a computer to execute steps or processes of the operation determination unit 21, the control unit 23 and the notification processing unit 24.

Here, the processor 101 means a CPU (Central processing Unit), a processing device, an arithmetic device, a microprocessor or the like.

The memory 102 may be a non-volatile or volatile semiconductor memory such as a RAM (Random Access Memory), a ROM (Read Only Memory) , an EPROM (Erasable Programmable ROM), a flash memory or the like; may be a magnetic disc such as a hard disc, a flexible disc or the like; or may be an optical disc such as a CD (Compact Disc) , a DVD (Digital Versatile Disc) or the like.

It is noted that the functions of the operation determination unit 21, the control unit 23 and the notification processing unit 24 may be implemented partly by dedicated hardware and partly by software or firmware. In this manner, using hardware, software, firmware or any combination thereof, the processing circuit in the input control device 20 can implement the above functions.

In the present invention, unlimited combination of the respective embodiments, modification of any configuration element in the embodiments and omission of any configuration element in the embodiments may be made, without departing from the scope of the invention.

Note that the input system 1 as described in each of the embodiments is not limited to being installed in a vehicle.

### INDUSTRIAL APPLICABILITY

The input system according to the invention is so configured as not to control the control target device until the decision operation is performed, and is thus suited as an input system employed in a vehicle or the like in which there exists both situations where the operator can perform a rotational operation and where he/she cannot perform the rotational operation.

### REFERENCE SIGNS LIST

1: input system, 10: input device, 11: operation device, 11a: protrusion, 11b: hollow portion, 11c: push button, 12: touch panel, 13: display, 20: input control device, 21: operation determination unit, 22: rotation amount storing unit, 23: control unit, 24: notification processing unit, 30: audio device (control target device), 31: air conditioner (control target device), 32: navigation device (control target device).

1. An input control device for controlling an input device including: an operation device having multiple protrusions; a touch panel for detecting contact positions of the multiple protrusions and pressing forces of the multiple protrusions; and a display integrated with the touch panel, the input control device comprising:
processing circuitry to
determine whether or not a rotational operation or a decision operation has been performed on the operation device, on a basis of at least either a set of the contact positions of the multiple protrusions or a set of the pressing forces of the multiple protrusions, detected by the touch panel;
store, when it is determined that the rotational operation has been performed, information of a rotation amount due to the rotational operation; and
control, when it is determined that the decision operation has been performed, a control target device by using the stored information of the rotation amount.

2. The input control device of claim 1, wherein the processing circuitry determines that the decision operation has been performed, when the operation device presses the touch panel.

3. The input control device of claim 2, wherein the processing circuitry determines that the operation device presses the touch panel, when all of the pressing forces of the multiple protrusions are each equal to or more than a threshold value.

4. The input control device of claim 2, wherein the processing circuitry determines that the operation device presses the touch panel, when an average value of all of the pressing forces of the multiple protrusions is equal to or more than a threshold value.

5. The input control device of claim 2, wherein the processing circuitry determines that the operation device presses the touch panel, when the pressing force of at least one protrusion among the multiple protrusions is equal to or more than a threshold value.

6. The input control device of claim 1, wherein, in a case where one of the multiple protrusions included in the operation device is formed as a push button, the processing circuitry determines that the decision operation has been performed, when the push button makes contact with the touch panel or when the push button presses the touch panel.

7. The input control device of claim 1, wherein the operation device is configured to form, at a center thereof, a hollow that allows the touch panel to be exposed therethrough; and
wherein the processing circuitry determines that the decision operation has been performed, when it detects that an object makes contact with, or presses the touch panel through the hollow.

8. The input control device of claim 1, wherein the processing circuitry determines whether or not a cancelling operation has been performed on the operation device, on a basis of at least one of a set of the contact positions of the multiple protrusions and a set of the pressing forces of the multiple protrusions, detected by the touch panel; and
wherein, when it is determined by the processing circuitry that the cancelling operation has been performed, the processing circuitry deletes the information of the rotation amount stored therein.

9. The input control device of claim 8, wherein the processing circuitry determines that the cancelling operation has been performed, when no operation is performed on the operation device within a predetermined period of time.

10. The input control device of claim 8, wherein the processing circuitry determines that the cancelling operation has been performed, when, within a predetermined period of time, the operation device is rotated clockwise and counterclockwise alternately predetermined times or more, by a rotation amount of more than, or not more than a predetermined rotation amount.

11. The input control device of claim 8, wherein the processing circuitry determines that the cancelling operation has been performed, when, within a predetermined period of time, the operation device presses the touch panel predetermined times or more, consecutively.

12. The input control device of claim 1, wherein the processing circuitry controls the control target device by using only information of the rotation amount in a rotational direction that is same as a rotational direction at a time when the operational operation for the operation device has started.

13. The input control device of claim 1, wherein the processing circuitry further generates notification information used for notifying an operator of a content of the determined operation.

14. An input system comprising:
an operation device having multiple protrusions;
a touch panel for detecting contact positions of the multiple protrusions and pressing forces of the multiple protrusions;
a display integrated with the touch panel; and
processing circuitry to
determine whether or not a rotational operation or a decision operation has been performed on the operation device, on a basis of at least either a set of the contact positions of the multiple protrusions or a set of the pressing forces of the multiple protrusions, detected by the touch panel;
store, when it is determined that the rotational operation has been performed, information of a rotation amount due to the rotational operation;
control, when it is determined that the decision operation has been performed, a control target device by using the stored information of the rotation amount.

15. An input control method for controlling an input device including: an operation device having multiple protrusions; a touch panel for detecting contact positions of the multiple protrusions and pressing forces of the multiple protrusions; and a display integrated with the touch panel, the method comprising:
determining whether or not a rotational operation or a decision operation has been performed on the operation device, on a basis of at least either a set of the contact positions of the multiple protrusions or a set of the pressing forces of the multiple protrusions, detected by the touch panel;
storing information of a rotation amount due to the rotational operation when it is determined that the rotational operation has been performed; and
controlling a control target device by using stored information of the rotation amount, when it is determined that the decision operation has been performed.
